(19) United States
(12) Patent Application Publication
(10) Pub. No.: US 2004/0033788 A1
(43) Pub. Date: Feb. 19, 2004

(54) Combined vehicle alarm transmitter and currency enclosure

(76) Inventor: Venecia S. Price, Kingwood, TX (US)

Correspondence Address: Ms. Venecia S. Price, 5619 Evergreen Valley Drive, Kingwood, TX, 77345, US

(21) Appl. No.: 10/223,653

(22) Filed: Aug. 19, 2002

(51) Int. Cl. H04B 1/034

(52) U.S. Cl. 455/100

(57) ABSTRACT

An combination enclosure or case for containing a vehicle security alarm remote transmitter and folded currency. The combination enclosure consists of flexible material to closely and fully receive the entire remote transmitter permitting the functionality of the transmitter as part of a key ring assembly to be independent of the condition of the integral transmitter key ring. The enclosure comprised of the front exterior panel containing a flexible transparent window permitting immediate through-the-case indication and operation of the transmitter pushbuttons. The rear panel consists of an exterior compartment for containing folded currency. The front and back exterior panels of the enclosure are joined on three sides with eyelet openings aligned on the bottom front and back panels to permit insertion of the driver's clip or key ring assembly that will secure the entire vehicle remote transmitter therein.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

1. Field of Invention

The present invention relates generally to cases or carrying enclosures and, more specifically, it relates to a case or enclosure for containing a vehicle security remote alarm transmitter combined with an enclosure for containing folded currency. The typical remote alarm transmitter has pushbuttons to control the vehicle alarm system and an integral key ring for attachment of the vehicle owner's keys.

2. Description of Prior Art

Many new vehicles today are equipped with alarm systems for the prevention against theft of the vehicle. In addition, older vehicles are often retrofitted with security alarm systems for prevention of theft of the vehicle and the property contained therein.

Remote keyless entry transmitters are a popular option for current vehicles as they enable the vehicle's driver to unlock and/or lock the vehicle doors while the driver is outside the vehicle. Typically, the transmitter consists of a small housing having dimensions of approximately 1″ square and ¼ inch thick containing the transmitter circuitry and a small battery power source. The housing has an integral aperture at one end to enable the entire remote keyless transmitter device to be attached to the driver's key ring assembly.

Several pushbuttons are mounted on one side of the transmitter housing for separate door lock and door unlock operations. Additional vehicle functions may also be controlled by separate pushbuttons provided on the housing, such as a trunk release pushbutton, a window operation pushbutton, a vehicle horn or alarm pushbutton. Depression of any pushbutton when the driver is located a short distance from the vehicle causes the transmitter to emit a radio frequency coded signal to a receiver mounted within the vehicle.

Currently, there is not an industry-wide standard design for vehicle remote alarm transmitters. This lack of standard design results in transmitters available in a wide variety of shapes, sizes, control pushbutton configurations and various methods for attaching to the owners keys.

Very often, the most common means of carrying the entire key chain assembly is for the driver to grasp, hold, or lift the assembly by the transmitter itself. This repetitive use, combined with the weight of the keys, results in strain that may ultimately result in breakage of the integral key chain ring aperture of the molded plastic transmitter housing rendering useless the functionality of the transmitter as part of the driver's key chain assembly.

Furthermore, vehicle owners often have an emergency or normal need for currency for a use in vending machines, making store purchases or for other reasons while participating in activities such as shopping, jogging, exercising, sporting events or in situations in which carrying a purse, pouch or billfold in inconvenient. The most common method is for the driver to carry currency separately from the transmitter key chain assembly, in a pocket, pouch or in a currency holder or billfold. Said invention provides for the driver to carry folded currency as an integral part of the proposed transmitter enclosure invention, thereby providing easy access to a limited amount of currency and eliminating the need to carry separate enclosures for currency and the vehicle transmitter.

The use of covers for portable electronic devices is known in the prior art. The use of enclosures for containing folded currency is also known as prior art. Cases formed of leather, vinyl, fabric, or molded plastic, have been constructed to cover portable electronic devices and provide a measure of protection to the rather delicate circuits contained in such devices. Such known cases do not provide for the combination of the transmitter and folded currency and are usually provided in only a few colors that may not always provide an attractive appearance or match the surroundings in which such devices are used, such as a vehicle interior.

Known prior art relating to vehicle security transmitter covers includes: U.S. Pat. Nos. 5,388,691; 5,678,204; 5,769,212; 5,850,754; 6,155,416; U.S. Pat. No. D448,157; and U.S. patent application No. 2001002003.

By way of examples, U.S. Pat. No. 5,388,691 discloses a rigid protective casing for a remote control transmitter with a clear plastic cover. This new invention differs in several aspects from this known prior art including, said new invention is not made of rigid plastic, does not contain a moveable cover for pushbutton access nor does this new invention rely on the use of the transmitters integral key ring as part of the driver's key ring assembly. Furthermore, this known prior art does not provide an integral enclosure for containing folded currency.

U.S. Pat. No. 5,678,204 discloses a protective cover for an electronic device which engages the sides of the transmitter and covers the actuation buttons and includes a plastic variation cover portion which can be moved to permit access to the buttons. This new invention differs in several aspects from this known prior art including, this new invention is of simple construction and does not contain a rigid moveable or hinged cover, does not require the operator to move the top portion of the cover to activate the pushbuttons and does not rely on the use of the integral transmitter key ring for attaching to the driver's key ring assembly. Furthermore, this known prior art does not provide an integral enclosure for containing folded currency.

U.S. Pat. No. 5,769,212 discloses a pouch with a key ring for an automotive alarm system remote control keypad. This new invention differs from this known prior art in several aspects including, this invention secures the transmitter therein using a clip or key ring connecting the front and back exterior walls at the bottom, provides for a flexible transparent window for accurate visual indication of the transmitter pushbutton and provides a compartment for securing folded currency.

U.S. Pat. No. 5,850,754 discloses a car alarm controller system that includes a main holder assembly and a key ring attachable insertion opening cover. This new invention differs from this known prior art in several aspects including, this invention is of simple construction designed to accommodate a variety of flexible and fashionable materials, does not consist of a replaceable flexible controller access opening cover and securing snaps and this new invention combines the transmitter controller enclosure with an integral folded currency compartment for the owners convenience.

U.S. Pat. No. 6,155,416 discloses a remote car alarm protective device comprised of a protective housing adapted for covering a remote transmitter car alarm. This new invention differs from this known prior art in several aspects including, this invention is not made of rigid material, does not require activation of a hinge for access to the pushbutton, is not required to be designed to exacting dimensions to contain the transmitter therein and does not rely on the use of the integral transmitter key ring for attaching to the driver's key ring assembly. In addition, this known prior art does not provide an integral enclosure for containing folded currency.

U.S. Pat. No. D448,157 discloses the ornamental design for a combined alarm case and key chain. This new invention differs from this known prior art in several aspects including this new invention consists of a one piece flexible transparent window, secures the transmitter therein using a clip inserted into front and rear exterior wall eyelets and provides an integral compartment for containing folded currency.

U.S. patent application No. 20010002003 discloses a flexible case for a portable electronic apparatus with through the case pushbutton activation. This new invention differs from this known prior art in several aspects including, this new invention is of simple construction, does not require exacting indicia in the shape of a pushbutton or indicia as a symbol defining the function of the associated pushbutton on the wall of the enclosure, does not consist of a flap and closure for securing the transmitter therein, does not contain a slot in the enclosure to receive the transmitter key ring and does not rely on the use of the integral transmitter key ring for attaching to the driver's key ring assembly. Furthermore, this known prior art does not provide an integral enclosure for containing folded currency.

Another known protective cover consists of a waterproof pouch that contains the entire transmitter. This new invention differs from this known prior art in several aspects including, this new invention is designed to closely receiver the transmitter and contains a flexible transparent window for through-the-case pushbutton activation. This new invention does not require the driver to open the pouch and remove the transmitter for activation of the pushbuttons. In addition, this known prior art does not provide an integral enclosure for containing folded currency.

While the aforementioned prior art fulfill their respective, particular objectives and requirements, the aforementioned prior art does not describe the instant invention as claimed. Thus, it is desirable that this invention provides an enclosure or case that is simple and economical to construct and operate that can be used in combination to contain a vehicle security remote transmitter and user provided folded currency. It would also be most desired that the said enclosure or case releasibly contain the entire transmitter therein and does not rely on the integrity of the transmitter key ring aperture, thereby eliminating the expense to the owner of replacing the entire transmitter due to a broken integral transmitter key ring aperture. Said enclosure is desired to be fashionable and made from a variety of flexible materials and colors providing an aesthetic appearance consistent with the expense or luxury level of the surroundings in which the apparatus is used or the luxurious appearance the user wishes to portray. Furthermore, said enclosure is desired to readily display the control pushbuttons, allows for the pushbuttons on the apparatus to be easily manipulated when the apparatus is contained within the case and to securely contain owner provided folded currency.

### BRIEF SUMMARY OF THE INVENTION

The present invention provides an enclosure or case, consisting of economical and simple construction comprised from fashionable flexible materials, which closely receives and protects a vehicle remote security transmitter therein, allows for use of the transmitter as part of a key chain assembly, even if the transmitter's original integral key ring is broken, allows for immediate visual indication and through-the-case manipulation of the transmitter pushbuttons by means of a transparent flexible window and provides in combination a compartment for securely containing a small amount of folded currency for the convenience of the driver.

### BRIEF DESCRIPTION OF THE SEVERAL VIEWS OF THE DRAWINGS

The various features, advantages and other uses of the present invention will become more apparent by referring to the following detailed description and drawing in which:

FIG. 1 is an exploded, perspective view of the case according to the present invention used with a typical remote vehicle keyless entry transmitter.

FIG. 2 is an end-rear perspective view of the present invention indicating the folded currency enclosure.

FIG. 3 is a rear-side perspective of the present invention showing the folded currency enclosure and a typical owner key ring assembly.

FIG. 4 is a side-front perspective of the present invention showing the transparent flexible window permitting through-the-case operation of the transmitter pushbuttons and a typical owner key ring assembly.

### DETAILED DESCRIPTION OF THE INVENTION

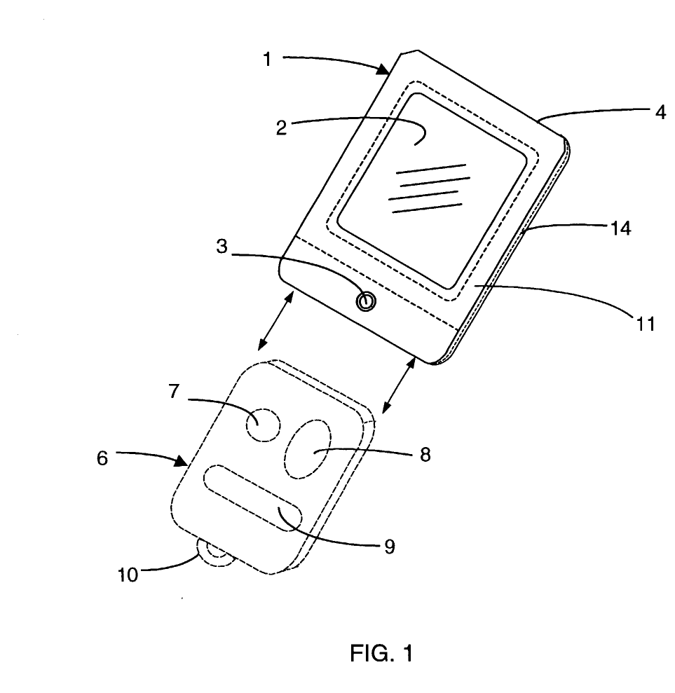

Referring now to FIGS. 1-4 in particular, there are depicted various embodiments of a case 1 for a remote keyless entry transmitter 6. The case is designed for simple, less costly construction while providing an aesthetic appearance, protective features, visibility, and immediate through-the-surface activation of the remote keyless transmitter pushbuttons, hereafter referred to as the transmitter 6. The broken lines in FIG. 1 showing the transmitter 6, pushbuttons 7, 8, 9 and integral transmitter key ring 10 are for illustrative purposes only and form no part of the claimed design. Said case is designed to securely contain folded currency if desired by the vehicle transmitter owner.

Referring now to the embodiments of a case 1 shown in FIGS. 1-4, the case 1 is formed with opposed major front and rear surfaces or walls 11 and 16, respectively, opposed side walls or side wall portions 13 and 14, an open bottom 12 formed at one end of the front, rear and side walls, 11, 16, 13 and 14 respectively, a closed top 4 formed at the opposite end of the open bottom 12, eyelet 3 formed at the bottom of front section 11, eyelet 17 at the bottom of rear section 16 and an exterior wall 18 formed by attaching three sides to rear surface 16 for containing folded currency.

Referring to case 1 shown in FIG. 1 the front surface 11 contains a transparent window 2 sized to make visible the transmitter pushbuttons 7, 8 and 9. The means for permitting operation of the transmitter pushbuttons is achieved by depressing the area of the transparent window 2 that is immediately adjacent to and above the transmitter pushbuttons 7, 8 and 9.

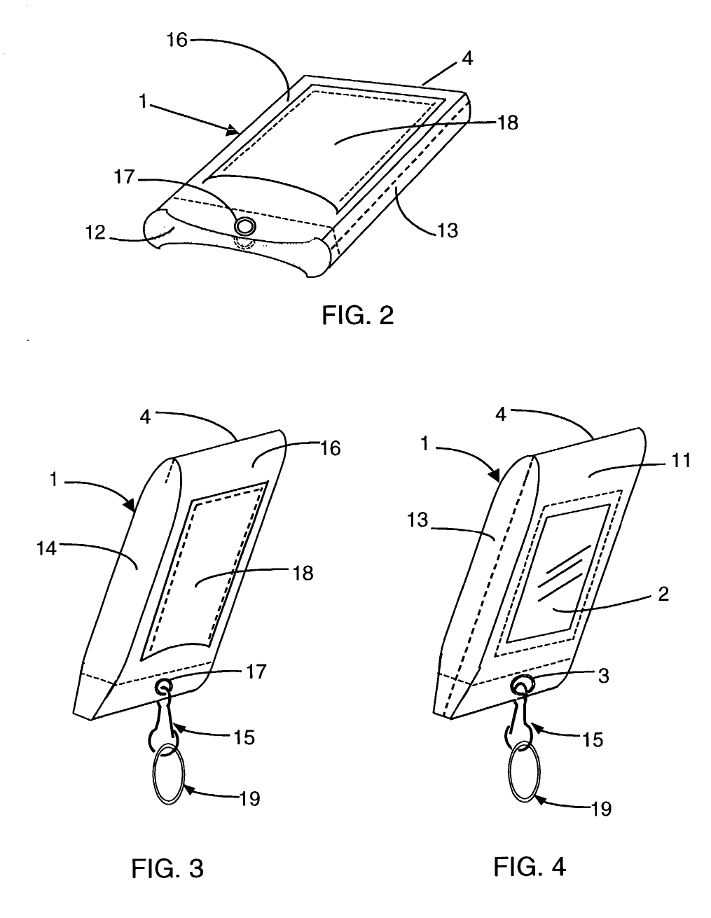

Referring to case 1 in FIG. 2 the rear surface 16 consists of an exterior wall 18 attached at two sides and one end for containing folded currency.

Referring to case 1 in FIG. 3 and FIG. 4, the clip 15 and ring 19 represent typical means for attaching the combination transmitter and currency holder enclosure or case to a user provided key chain assembly.

It will be understood that regardless of the specific quantity or arrangement of control buttons 7, 8 and 9, of the typical transmitter 6, the design of case 1 includes a transparent window 2 which is designed to display and allow for through-the-transparent window 2 depression of any or all of the control buttons typically depicted as 7, 8 and 9 and does not require exacting indicia of the pushbuttons on the enclosure wall.

It will be understood that regardless of the specific construction described hereafter, each of the front and rear surfaces 11 and 16, the side walls 13 and 14, the open bottom 12 the closed top 4 or the exterior surface 18 may be constructed of individual members or pieces which can be joined together by any suitable means or process, such as by stitching, to form the case 1 shown in FIGS. 1-4. However, in a preferred embodiment, the case 1 is constructed with the front and rear surfaces 11 and 16 formed as a single piece, unitary member of a suitable material described hereafter. The side wall 13 is formed by stitching front, rear and top surfaces 11, 16, and 4. The opposing side wall 14 is formed from a fold or bend created between front and rear surfaces 11 and 16 and does not necessarily contain stitching. The exterior wall 18 is formed by stitching two sides and one end to the rear wall 16.

The width of the side walls 13 and 14 and of the top surface 4 is selected to form an interior chamber or cavity within the case 1 extending from a bottom open end 12 and having appropriate dimensions for snugly and releasibly receiving the remote keyless transmitter 6 including the integral key ring aperture 10. The width and length of exterior wall 18 is selected to securely contain a limited amount of folded currency.

An opening, preferably in the form of a rounded hole created by insertion of an eyelet 3 and 17 is formed in the portions of front and rear surfaces 11 and 16, generally near the bottom of the case 1. The opening formed by the eyelets 3 and 17 has the size and shape to enable the clip 15 to be inserted through the front and rear surfaces 11 and 16 after the transmitter 6 has been inserted into the case 1.

The design of case 1 allows for the insertion and removal of the entire transmitter 6 through the bottom opening 12. Case 1 is designed to receive all of the transmitter 6 including any portion or all of the transmitter's integral key ring 10, excluding keys, and therefore does not rely on the condition of the transmitter integral key ring 10 as the normal means for securing the owner key ring assembly attached via clip 15 and ring 19 to the transmitter 6.

The insertion of clip 15 through eyelets 3 and 17 secures the transmitter 6 within the case 1 and allows for attaching the entire assembly to the owner's key ring assembly 15 and 19.

Case 1, excluding transparent window 2, may be formed of a number of different flexible materials including, but not limited to leather, vinyl, cloth or fabric including stretchable waterproof materials, fiberglass mesh, etc. This enables case 1 to be soft and comfortable when inserted into the driver's pocket and allows the driver to select the desired fashionable appearance for the combination transmitter and folded currency enclosure, permits simple construction and allows for securely containing the transmitter within.

The transparent window 2 may be formed of any transparent or semi-transparent flexible material including, but not limited to clear vinyl, plastic, semi-opaque cloth or fabric or fiberglass mesh to permit visual indication and through-the-wall activation of the transmitter pushbuttons. This through-the case visibility eliminates the need for embossing or imprinting the transmitter pushbutton indicia such as 7, 8, 9 on the enclosure wall 11.

Thus, there has been disclosed a unique enclosure or case for a combination vehicle remote transmitter and folded currency holder which is of economical and simple construction that releasibly receives the entire vehicle remote transmitter, including the integral transmitter key ring. The enclosure or case does not rely on an intact integral transmitter key ring for attachment of the owner's key ring assembly and therefore provides for extended use of the transmitter and elimination of the expense of replacing the entire transmitter because of a broken integral transmitter key chain ring. The enclosure provides a protective and decorative appearance for the transmitter and enables the various control pushbuttons on the transmitter to be immediately visible and operated directly through the wall of the case while providing a closed surface over the transmitter pushbuttons. The combination enclosure provides access to folded currency to be used for emergency or convenience purposes.

What I claim as my invention is:

1. An enclosure or case for closely receiving a vehicle security alarm remote transmitter and folded currency, the transmitter having at least one manipulatable external pushbutton and one integral key ring, the enclosure or case being of simple construction whose walls are comprised of flexible materials such as leather, vinyl, fiberglass mesh, cloth or fabric including stretchable waterproof materials and defining an interior cavity sized for closely receiving the entire vehicle remote transmitter, including the transmitter integral key ring, if any, therein; a flexible transparent window on one exterior wall sized to align with any or all pushbuttons for through-the-case manipulation and visible pushbutton indicating means; an exterior flexible cavity attached to the opposing enclosure wall sized for securely receiving folded currency.

2. The enclosure or case of claim 1 wherein the means of through-the-case viewing and activating the transmitter pushbuttons is comprised of a flexible transparent window constructed of materials such as vinyl, plastic or mesh sized to properly display the transmitter pushbuttons.

3. The enclosure or case of claim 1 wherein the compartment for securing folded currency is comprised of similar flexible material attached to the exterior wall that opposes the exterior wall comprising the flexible transparent window.
